(19) United States
(12) Patent Application Publication
(10) Pub. No.: US 2004/0213219 A1
(43) Pub. Date: Oct. 28, 2004

(54) Method and apparatus to handle the flow control in a cascaded configuration

(76) Inventors: Sridhar Lakshmanamurthy, Sunnyvale, CA (US); Lawrence B. Huston, San Jose, CA (US); Yim Pun, Saratoga, CA (US); Raymond Ng, Fremont, CA (US); Hugh M. Wilkinson III, Newton, MA (US); Mark B. Rosenbluth, Uxbridge, MA (US)

Correspondence Address: Kenyon & Kenyon, 333 W. San Carlos Street, Suite 600, San Jose, CA, 95110, US

(21) Appl. No.: 10/188,951

(22) Filed: Jul. 3, 2002

(51) Int. Cl. G06F 9/00; H04Q 11/00; H04L 12/50

(52) U.S. Cl. 370/388

(57) ABSTRACT

A system and a method for creating a serial chain of processors on a line card to allow longer processing time on a data set is disclosed. Each processor in the chain partially processes the data set, converts the data set to an interface protocol, and then transmits the data set to the next processor in the chain. A bus interconnects each processor in the chain with the processor immediately precedent, allowing flow control information to be sent back. A loop back configuration can allow for additional processing of data within a switching fabric before transmission to a network.

### BACKGROUND INFORMATION

The present invention relates to switches. More specifically, the present invention relates to a method of improving line-processing functionality in switches.

Line cards are often used to process data on a network line. Each line card acts as an interface between a network and a switching fabric. The line card may convert the data set from the format used by the network to a format for processing. The line card also may perform necessary processing on the data set. This processing may include further translation, encryption, error checking, and the like. After processing, the line card converts the data set into a transmission format for transmission across the switching fabric.

The line card also allows a data set to be transmitted from the switching fabric to the network. The line card receives a data set from the switching fabric, processes the data set, and then converts the data set into the network format. The network format can be asynchronous transfer mode (ATM; Multiprotocol Over ATM, Version 1.0, July 1998) or a different format.

Often the amount of processing that needs to be performed on a data set can exceed the capabilities of an individual processor. As data sets arrive at a set clock rate, a processor might not be finished processing one data set before the next data set arrives. As these processing acts are often sequential, more processing capacity is not always the answer. Accordingly, there is a need for a method and a system that increase processor efficiency.

### BRIEF DESCRIPTION OF THE DRAWINGS

FIG. 1 provides an illustration of a line card interfacing with a switching fabric.

FIG. 2 provides an illustration of one embodiment of a processor system.

FIG. 3 provides an illustration of a serial chain of processors in a line card interfacing with a switching fabric.

FIGS. 4a-c describe in a flowchart one embodiment of the processes performed by a serial chain of ingress processors.

FIGS. 5a-c describe in a flowchart one embodiment of the processes performed by a serial chain of ingress processors.

FIG. 6 provides in an illustration one embodiment of a loopback line card.

### DETAILED DESCRIPTION

A system and a method for creating a serial chain of processors on a line card that may allow longer processing time on a data set is disclosed. In one embodiment, each processor in the chain partially processes the data set, converts the data set to an interface protocol, and then transmits the data set to the next processor in the chain. A bus interconnects each processor in the chain with the processor immediately precedent, allowing flow control information to be sent back. A loop back configuration may allow for additional processing of data within a switching fabric before transmission to a network.

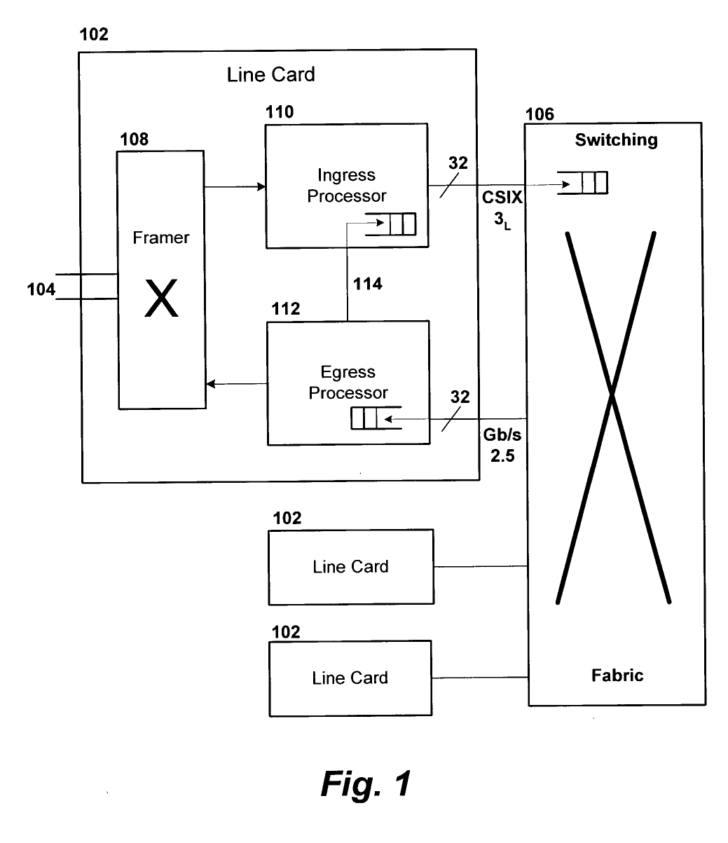

One embodiment of a line card 102 used to process data on a network line is illustrated in FIG. 1. Each line card acts as an interface between a network 104 and a switching fabric 106. The line card 102 receives a data set from the network 104 via a framer 108. The framer 108 converts the data set from the format used by the network, which may include segmenting the data set, to a format for processing. The converted data set is then transmitted to an ingress processor 110. The ingress processor 110 performs necessary processing on the data set before being forwarded to the switching fabric 106. This processing may include further translation, encryption, error checking, and the like. After processing, the ingress processor 110 converts the data set into a transmission format for transmission across the switching fabric 106, then transmits the data set to the switching fabric 106. The transmission format may be common switch interface (CSIX) format (Common Switch Interface Specification-L1, August 2000), or a different format.

The line card 102 also allows a data set to be transmitted from the switching fabric 106 to the network 104. An egress processor 112 receives a data set from the switching fabric 106, processes the data set, and then transmits the data set to the framer 108. The framer 108 converts the data set into the network format. The network format can be asynchronous transfer mode (ATM; Multiprotocol Over ATM, Version 1.0, July 1998) or a different format.

A CSIX bus (CBUS) 114 carries flow control information from the egress processor to the ingress processor. CSIX link level or fabric level flow control messages that originate in either the switch fabric or the egress processor are transmitted over the CBUS.

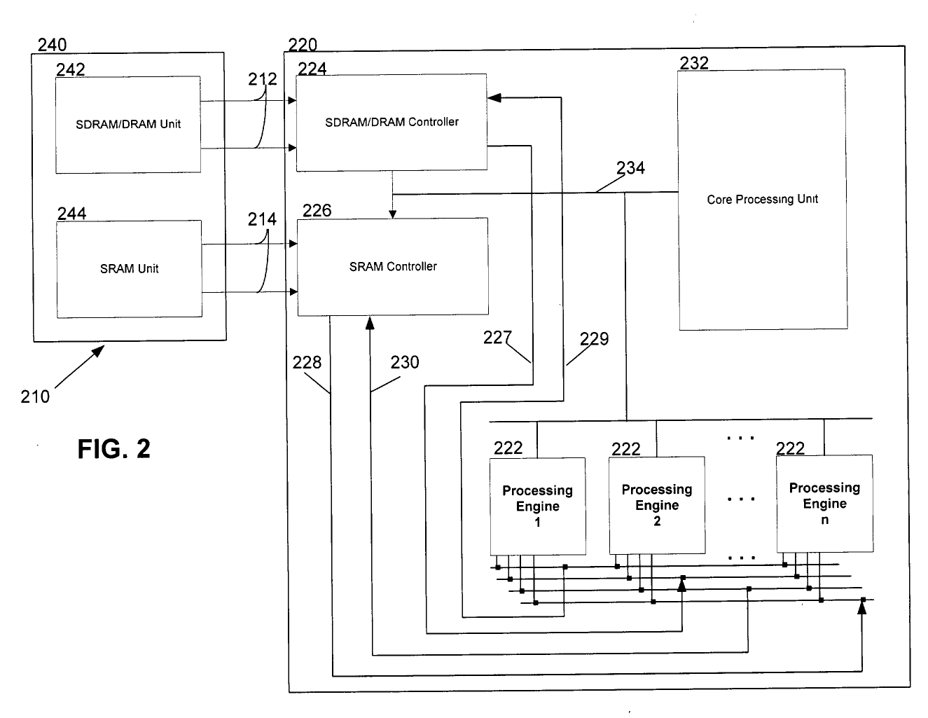

FIG. 2 is a block diagram of a processing system, in accordance with an embodiment of the present invention. In FIG. 2, a computer processor system 210 may include a parallel, hardware-based multithreaded network processor 220 coupled by a pair of memory buses 212, 214 to a memory system or memory resource 240. Memory system 240 may include a synchronous dynamic random access memory (SDRAM) unit 242 and a static random access memory (SRAM) unit 244. The processor system 210 may be especially useful for tasks that can be broken into parallel subtasks or operations. Specifically, hardware-based multithreaded processor 220 may be useful for tasks that require numerous simultaneous procedures rather than numerous sequential procedures. Hardware-based multithreaded processor 220 may have multiple microengines or processing engines 222 each processing multiple hardware-controlled threads that may be simultaneously active and independently worked to achieve a specific task.

Processing engines 222 each may maintain program counters in hardware and states associated with the program counters. Effectively, corresponding sets of threads may be simultaneously active on each processing engine 222.

In FIG. 2, in accordance with an embodiment of the present invention, multiple processing engines 1-n 222, where (for example) n=8, may be implemented with each processing engine 222 having capabilities for processing eight hardware threads. The eight processing engines 222 may operate with shared resources including memory resource 240 and bus interfaces. The hardware-based multithreaded processor 220 may include a SDRAM/dynamic random access memory (DRAM) controller 224 and a SRAM controller 226. SDRAM/DRAM unit 242 and SDRAM/DRAM controller 224 may be used for processing large volumes of data, for example, processing of network payloads from network packets. SRAM unit 244 and SRAM controller 226 may be used in a networking implementation for low latency, fast access tasks, for example, accessing look-up tables, core processor memory, and the like.

In accordance with an embodiment of the present invention, push buses 227, 228 and pull buses 229, 230 may be used to transfer data between processing engines 222 and SDRAM/DRAM unit 242 and SRAM unit 244. In particular, push buses 227, 228 may be unidirectional buses that move the data from memory resource 240 to processing engines 222 whereas pull buses 229, 230 may move data from processing engines 222 to their associated SDRAM/DRAM unit 242 and SRAM unit 244 in memory resource 240.

In accordance with an embodiment of the present invention, eight processing engines 222 may access either SDRAM/DRAM unit 242 or SRAM unit 244 based on characteristics of the data. Thus, low latency, low bandwidth data may be stored in and fetched from SRAM unit 244, whereas higher bandwidth data for which latency is not as important, may be stored in and fetched from SDRAM/DRAM unit 242. Processing engines 222 may execute memory reference instructions to either SDRAM/DRAM controller 224 or SRAM controller 226.

In accordance with an embodiment of the present invention, the hardware-based multithreaded processor 220 also may include a core processing unit 232 for loading microcode control for other resources of the hardware-based multithreaded processor 220. In this example, core processing unit 232 may have a XScale™-based architecture manufactured by Intel Corporation of Santa Clara, Calif. A processor bus 234 may couple core processing unit 232 to SDRAM/DRAM controller 224 and SRAM controller 226.

The core processing unit 232 may perform general purpose computer type functions such as handling protocols, exceptions, and extra support for packet processing where processing engines 222 may pass the packets off for more detailed processing such as in boundary conditions. Core processing unit 232 may execute operating system (OS) code. Through the OS, core processing unit 232 may call functions to operate on processing engines 222. Core processing unit 232 may use any supported OS, such as, a real time OS. In an embodiment of the present invention, core processing unit 232 may be implemented as an XScale™ architecture, using, for example, operating systems such as VXWorks operating system from Wind River International of Alameda, Calif.; μC/OS operating system, from Micrium, Inc. of Weston, Fla., etc.

Advantages of hardware multithreading may be explained in relation to SRAM or SDRAM/DRAM accesses. As an example, an SRAM access requested by a thread from one of processing engines 222 may cause SRAM controller 226 to initiate an access to SRAM unit 244. SRAM controller 226 may access SRAM memory unit 226, fetch the data from SRAM unit 226, and return data to the requesting processing engine 222.

During a SRAM access, if one of processing engines 222 had only a single thread that could operate, that one processing engine would be dormant until data was returned from the SRAM unit 244.

By employing hardware thread swapping within each of processing engines 222 the hardware thread swapping may enable other threads with unique program counters to execute in that same processing engine. Thus, a second thread may function while the first may await the read data to return. During execution, the second thread accesses SDRAM/DRAM unit 242. In general, while the second thread may operate on SDRAM/DRAM unit 242, and the first thread may operate on SRAM unit 244, a third thread, may also operate in a third one of processing engines 222. The third thread may be executed for a certain amount of time until it needs to access memory or perform some other long latency operation, such as making an access to a bus interface. Therefore, processor 220 may have simultaneously executing bus, SRAM and SDRAM/DRAM operations that are all being completed or operated upon by one of processing engines 222 and have one more thread available to be processed.

The hardware thread swapping may also synchronize completion of tasks. For example, if two threads hit a shared memory resource, for example, SRAM memory unit 244, each one of the separate functional units, for example, SRAM controller 226 and SDRAM/DRAM controller 224, may report back a flag signaling completion of an operation upon completion of a requested task from one of the processing engine thread. Once the processing engine executing the requesting thread receives the flag, the processing engine may determine which thread to turn on.

In an embodiment of the present invention, the hardware-based multithreaded processor 220 may be used as a network processor. As a network processor, hardware-based multithreaded processor 220 may interface to network devices such as a Media Access Control (MAC) device, for example, a 10/100BaseT Octal MAC device or a Gigabit Ethernet device (not shown). In general, as a network processor, hardware-based multithreaded processor 220 may interface to any type of communication device or interface that receives or sends a large amount of data. Similarly, computer processor system 210 may function in a networking application to receive network packets and process those packets in a parallel manner.

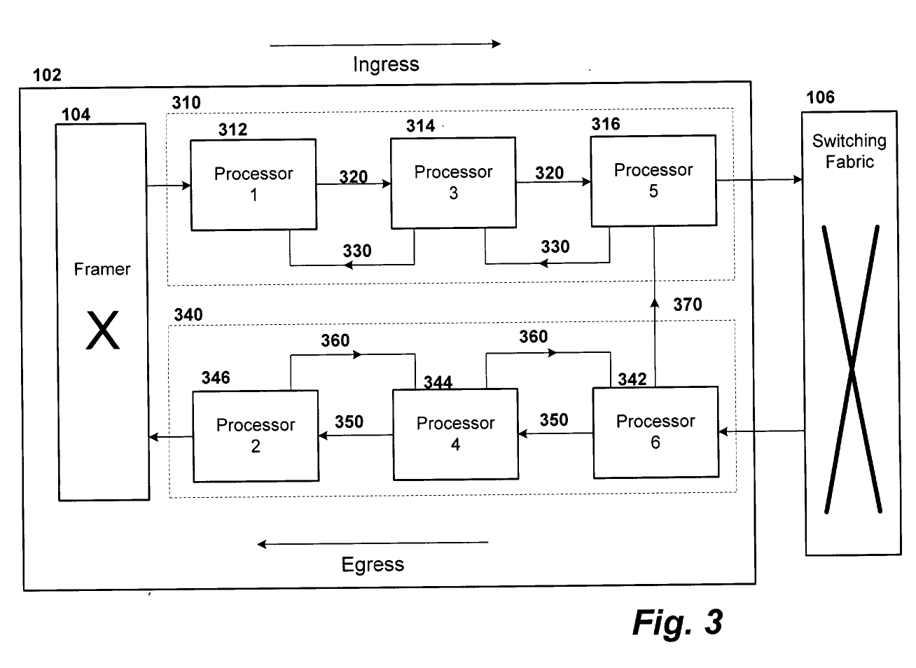

One embodiment of a serial chain of processors is illustrated in FIG. 3. The serial chain of processors can perform processing on a data set being transmitted. In one embodiment, such processing can include further translation, encryption, error checking, classification, and the like. In one embodiment, a plurality of ingress processors are serially connected to form a serial chain of ingress processors 310, with each ingress processor connected to the next ingress processor with an interface, such as one operating according to a CSIX 320. A data set starts in the initial processor 312 (e.g. such as processor 220 in FIG. 2) in the chain and is passed to each intermediate processor 314 by the immediately precedent processor until it reaches the final processor 316 in the chain. In one embodiment the chain consists solely of an initial processor 312 and a final processor 316, with no intermediate processors. In an alternate embodiment, a serial chain has a plurality of intermediate processors 314. In a further embodiment, a secondary interface, such as a CBUS 330, connects each processor with the immediately adjacent processor. The subsequent processors in the chain are able to push data, such as flow control information, along the CBUS 330 to the precedent processor in the chain. In one embodiment, the initial processor in the serial chain of ingress processors receives the data set from the framer 104 and the final processor in the serial chain of ingress processors transmits the data set to switching fabric 106.

In one embodiment, a plurality of egress processors 340 are serially connected to form a serial chain of egress processors, with each egress processor connected to the next egress processor by a CSIX interface 350. A data set starts in the initial egress processor 342 in the chain and is passed to each intermediate processor 344 by the immediately precedent processor until it reaches the final processor 346 in the chain. In one embodiment the chain consists solely of an initial processor 342 and a final processor 346, with no intermediate processors 344. In an alternate embodiment, a serial chain has a plurality of intermediate processors 344. In a further embodiment, a CBUS 360 connects each processor with the immediately adjacent processor. The subsequent processors in the chain are able to push data along the CBUS 360 to the precedent processor in the chain. In one embodiment, the initial processor 342 in the serial chain of egress processors receives the data set from the switching fabric 106 and the final processor in the serial chain of egress processors transmits the data set to the framer 104. An inter-chain bus 370 connects the initial egress processor 342 to the final ingress processor 316.

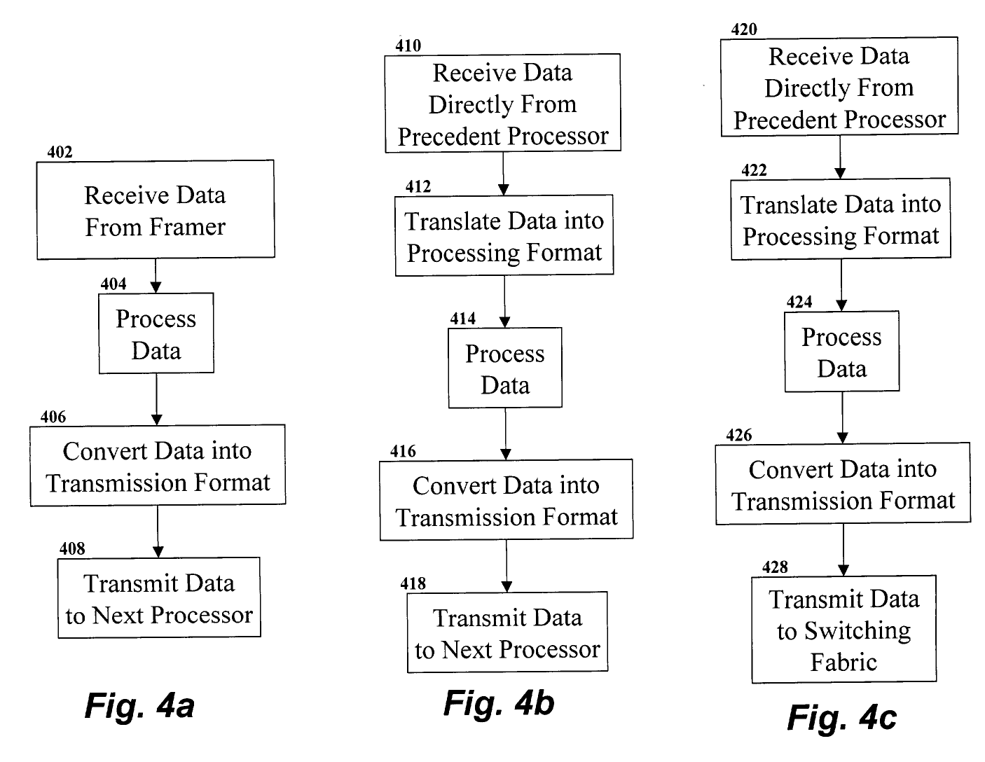

The flowcharts of FIG. 4a-c illustrate one embodiment of the processes performed by the processors of the serial chain of ingress processors 310. In FIG. 4a, the initial processor 312 of the serial chain of ingress processors receives a data set from the framer 104 (Block 402). The processor 312 then performs as much of the required processing on the data set as time allows before the next data set is transmitted to the processor (Block 404). In one embodiment, when calculating the amount of time available for processing, time for translation into transmission format should be taken into consideration. After the processing duties allotted to the initial processor have been fulfilled, the data set is converted into a transmission format (Block 406). In one embodiment, that transmission format is according to CSIX protocol. The converted data set is then transmitted to the next processor in the chain (Block 408).

In FIG. 4b, intermediate processors 414 in the serial chain of ingress processors receive a data set from the immediately precedent processor (Block 410). The processor 414 then translates the data set from the transmission format to a processing format (Block 412). The processor 414 then continues processing on the data set, performing as much processing as time allows (Block 414). After the processing duties allotted to that intermediate processor 414 have been fulfilled, the data set is converted into the transmission format (Block 416). The converted data set is then transmitted to the next processor in the chain (Block 418).

In FIG. 4c, the final processor 416 in the serial chain of ingress processors receives a data set from the immediately previous processor (Block 420). The processor 416 then translates the data set from the transmission format to a processing format (Block 422). The processor 416 then continues processing on the data set, performing as much processing as time allows (Block 424). After the processing operations are completed, the data set is converted back into the transmission format (Block 426). The converted data set is then transmitted to the switching fabric (Block 428).

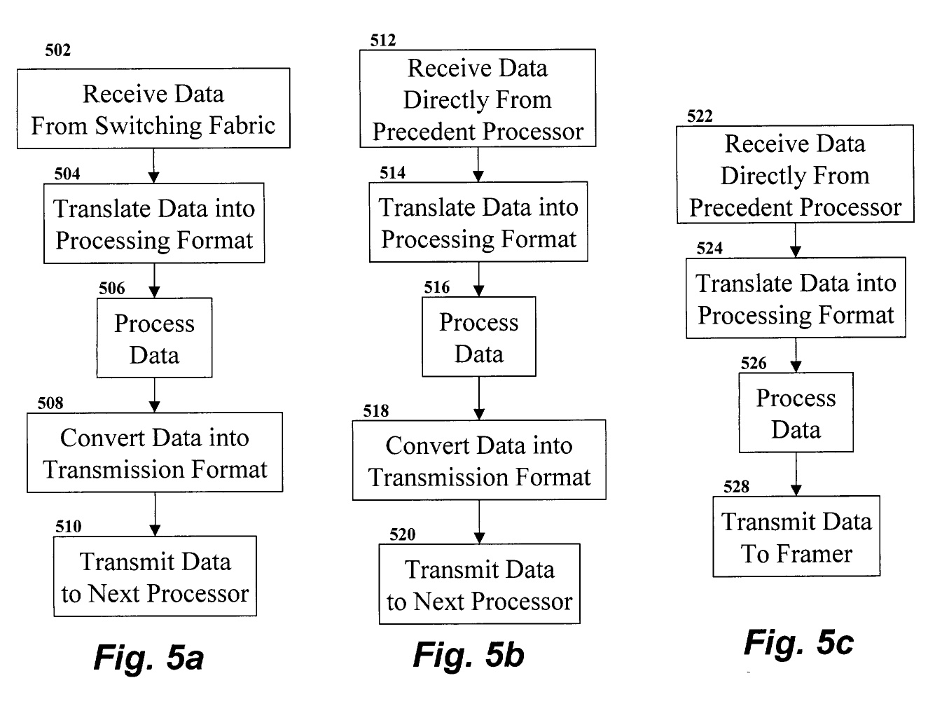

The flowcharts of FIG. 5a-c illustrate one embodiment of the processes performed by the processors of the serial chain of egress processors 340. In FIG. 5a, the initial processor 342 of the serial chain of egress processors receives a data set from the switching fabric 106 (Block 502). The processor then translates the data set from the transmission format to a processing format (Block 504). The processor 342 then performs as much of the required processing on the data set as time allows before the next data set is transmitted to the processor (Block 506). After the processing duties allotted to the initial processor have been fulfilled, the data set is converted back to a transmission format (Block 508). In one embodiment, that transmission format is according to CSIX protocol. The converted data set is then transmitted to the next processor in the chain (Block 510).

In FIG. 5b, intermediate processors 444 in the serial chain of egress processors receive a data set from the immediately precedent processor (Block 512). The processor then translates the data set from the transmission format to a processing format (Block 514). The processor 444 then continues processing on the data set, performing as much processing as time allows (Block 516). After the processing duties allotted to that intermediate processor 444 have been fulfilled, the data set is converted into the transmission format (Block 518). The converted data set is then transmitted to the next processor in the chain (Block 520).

In FIG. 5c, the final processor 446 in the serial chain of ingress processors 440 receives a data set from the immediately previous processor (Block 522). The processor 446 then translates the data set from the transmission format to a processing format (Block 524). The processor 446 then continues processing on the data set, performing as much processing as time allows (Block 526). After the processing operations are completed, the data set is then transmitted to the framer for transmission to a network (Block 528).

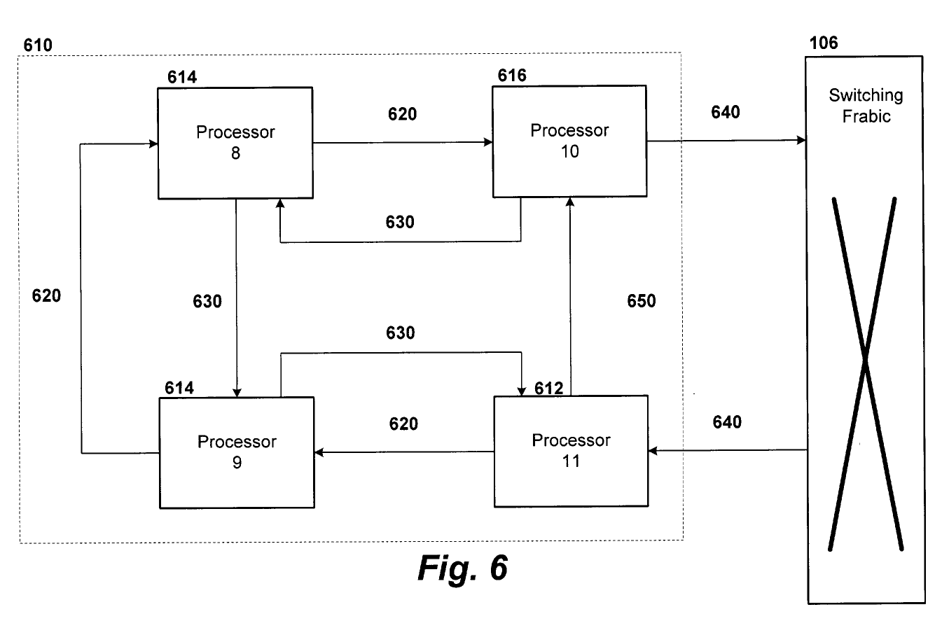

FIG. 6 illustrates an additional embodiment of a serial chain of processors, as used in a loopback card. A loopback card can be used in applications that require a particular line card to process all incoming traffic from the switching fabric 106 and transmit the traffic back into the fabric once processing is complete. In one embodiment, such processing can include time division multiplexing, further encryption, and the like. In one embodiment, the loopback card has a single serial chain of processors 610. In one embodiment, each processor is connected to the next processor by a CSIX interface 620. A data set starts in the initial processor 612 in the chain and is passed to each intermediate processor 614 by the immediately precedent processor until it reaches the final processor 616. In one embodiment the chain consists solely of an initial processor 612 and a final processor 616, with no intermediate processors 614. In an alternate embodiment, a serial chain has a plurality of intermediate processors 614. In a further embodiment, a CBUS 630 connects each processor with the immediately adjacent processor. The subsequent processors in the chain are able to push data along the CBUS 630 to the precedent processor in the chain. The initial processor 612 and the final processor 616 receive data from and send data to the switching fabric via a CSIX interface 640. A further CBUS 650 allows the initial processor 612 to push data to the final processor 616, which can then be relayed to the switching fabric 106. In one embodiment this data includes flow control information.

Although several embodiments are specifically illustrated and described herein, it will be appreciated that modifications and variations of the present invention are covered by the above teachings and within the purview of the appended claims without departing from the spirit and intended scope of the invention.

What is claimed is:

1. A line card, comprising:
a first serial chain of processors including
an initial processor to process a first data set, to convert the first data set into a transmission format after processing, and to transmit the first data set in the transmission format; and
at least one subsequent processor to receive the converted first data set directly from the initial processor in the first serial chain of processors, to translate the first data set into a processing format, to process the first data set, and to reconvert the first data set back into a transmission format.

2. The line card of claim 1, wherein the first serial chain of processors further includes a bus for each subsequent processor to transmit a second data set from the subsequent processor to an immediate preceding processor.

3. The line card of claim 2, wherein the second data set is control flow information.

4. The line card of claim 2, further comprising an output serial port to receive the first data set from a final processor in the first serial chain of processors and to transmit the first data set to a switching fabric.

5. The line card of claim 4, further comprising an input serial port to receive the first data set from the switching fabric and to transmit the first data set to the initial processor in the first serial chain of processors.

6. The line card of claim 4, further comprising:
a second serial chain of processors including
at least one processor to receive a third data set in the transmission format, to translate the third data set into the processing format, to process the third data set, and to reconvert the third data set back into the transmission format;
a final processor to translate the third data set into the processing format and to subsequently process the third data set; and
a bus for each processor except an initial processor in the second serial chain of processors, the bus to transmit a fourth data set from each processor to the immediate preceding processor; and
a bus to transmit a fifth data set from the initial processor in the second serial chain of processors to a final processor in the first serial chain of processors.

7. The line card of claim 6, further comprising an input serial port to receive the third data set from a switching fabric and to transmit the third data set to the initial processor in the second serial chain of processors.

8. The line card of claim 7, further comprising a framer to connect a network to the first and second serial chain of processors, the framer to translate between a network format and the processing format.

9. The line card of claim 1, wherein the transmission format is common switch interface protocol.

10. A system, comprising:
a first serial chain of processors including
an initial processor to process a first data set and to subsequently convert the first data set into a transmission format; and
at least one subsequent processor to receive the converted first data set directly from the initial processor in the serial chain of processors, to translate the first data set into a processing format, to process the first data set, and to reconvert the first data set back into a transmission format.

11. The system of claim 10, wherein the first serial chain of processors further includes a bus for each subsequent processor to transmit a second data set from the subsequent processor to the immediate preceding processor.

12. The system of claim 11, wherein the second data set is control flow information.

13. The system of claim 11, further comprising:
a switching fabric; and
an output serial port to receive the first data set from the final processor in the first serial chain of processors and to transmit the first data set to the switching fabric.

14. The system of claim 13, further comprising:
an input serial port to receive the first data set from the switching fabric and to transmit the first data set to an initial processor in the first serial chain of processors.

15. The system of claim 13, further comprising:
a second serial chain of processors including
at least one processor to receive a third data set in the transmission format, to translate the third data set into the processing format, to process the third data set, and to reconvert the third data set back into the transmission format;
a final processor to translate the third data set into the processing format and to subsequently process the third data set; and
a bus for each processor except an initial processor in the second serial chain of processors, the bus to transmit a fourth data set from each processor to the immediate preceding processor; and
a bus to transmit a fifth data set from the initial processor in the second serial chain of processors to a final processor in the first serial chain of processors.

16. The system of claim 15, further comprising an input port to receive the third data set from the switching fabric and to transmit the third data set to the initial processor in the second serial chain of processors.

17. The system of claim 16, further comprising a framer to connect a network to the first and second serial chain of processors, the framer to translate between a network format and the processing format.

18. The system of claim 10, wherein the transmission format is common switch interface protocol.

19. A method, comprising:
using an initial processor in a first serial chain of processors to process a first data set;
converting the first data set into a transmission format after processing;
transmitting the first data set in the transmission format directly to a subsequent processor in the serial chain of processors;
receiving with the subsequent processor the converted first data set;
translating the first data set into a processing format;
processing the first data set;
reconverting the first data set into the transmission format; and
transmitting the first data set in the transmission format.

20. The method of claim 19, further comprising:
transmitting a second data set from the subsequent processor to the initial processor via a first bus.

21. The method of claim 20, wherein the second data set is control flow information.

22. The method of claim 20, further comprising:
transmitting the first data set from a final processor of the first serial chain of processors to a switching fabric.

23. The method of claim 22, further comprising:
receiving in the initial processor of the first serial chain of processors the, first data set from a switching fabric.

24. The method of claim 22, further comprising:
using an initial processor of a second serial chain of processor to receive a third data set;
translating the third data set into a processing format;
processing the third data set;
reconverting the third data set back into the transmission format;
transmitting the third data set in the transmission format directly to a subsequent processor;
receiving with a final processor the converted third data set directly from a precedent processor in the second serial chain of processors;
translating the third data set into a processing format;
processing the third data set; and
transmitting a fourth data set from the initial processor in the second serial chain of processors to the final processor in the first serial chain of processors via a second bus.

25. The method of claim 24, further comprising:
receiving in the initial processor of the second serial chain of processors the second data set from the switching fabric.

26. The method of claim 25, further comprising:
translating with a framer the first data set from a network format to the processing format;
transmitting the first data set from the framer to the initial processor of the first serial chain of processors;
transmitting the second data set to the framer from the final processor of the second serial chain of processors; and
translating the second data set from a processing format to the network format.

27. The method of claim 19, wherein the transmission format is common switch interface protocol.

28. A set of instructions residing in a storage medium, said set of instructions capable of being executed by a processor to implement a method for processing data over a serial chain of processors, the method comprising:
using an initial processor in a first serial chain of processors to process a first data set;
converting the first data set into a transmission format after processing;
transmitting the first data set in the transmission format directly to a subsequent processor in the serial chain of processors;
receiving with the subsequent processor the converted first data set;
translating the first data set into a processing format;
processing the first data set;
reconverting the first data set into the transmission format; and
transmitting the first data set in the transmission format.

29. The set of instructions of claim 28, further comprising:
transmitting a second data set from the subsequent processor to the initial processor via a first bus.

30. The set of instructions of claim 29, wherein the second data set is control flow information.

31. The set of instructions of claim 29, further comprising:
transmitting the first data set from a final processor of the first serial chain of processors to a switching fabric.

32. The set of instructions of claim 31, further comprising:
receiving in the initial processor of the first serial chain of processors the first data set from a switching fabric.

33. The set of instructions of claim 31, further comprising:
using an initial processor of a second serial chain of processor to receive a third data set;
translating the third data set into a processing format;
processing the third data set;
reconverting the third data set back into the transmission format;
transmitting the third data set in the transmission format directly to a subsequent processor;
receiving with a final processor the converted third data set directly from a precedent processor in the second serial chain of processors;
translating the third data set into a processing format;
processing the third data set; and
transmitting a fourth data set from the initial processor in the second serial chain of processors to the final processor in the first serial chain of processors via a second bus.

34. The set of instructions of claim 33, further comprising:
receiving in the initial processor of the second serial chain of processors the second data set from the switching fabric.

35. The set of instructions of claim 34, further comprising:
translating with a framer the first data set from a network format to the processing format;
transmitting the first data set from the framer to the initial processor of the first serial chain of processors;
transmitting the second data set to the framer from the final processor of the second serial chain of processors; and
translating the second data set from a processing format to the network format.

36. The set of instructions of claim 35, wherein the transmission format is common switch interface protocol.
